(19) United States
(12) Patent Application Publication
(10) Pub. No.: US 2006/0232190 A1
(43) Pub. Date: Oct. 19, 2006

(54) Electron emission device and method for manufacturing the same

(76) Inventor: Chang-Soo Lee, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/349,954

(22) Filed: Feb. 9, 2006

(30) Foreign Application Priority Data
Feb. 28, 2005 (KR) 10-2005-0016843

(51) Int. Cl. H01J 1/62

(52) U.S. Cl. 313/497

(57) ABSTRACT

Embodiments of the present invention include an electron emission device having a multi-layered focusing electrode, display devices including the same, and a method for manufacturing the same. In an embodiment, the electron emission device includes an electron emission region, a focusing electrode formed on an insulating layer, and an opening passing through the focusing electrode and the insulating layer, the opening corresponding to the electron emission region, wherein the focusing electrode includes a plurality of focusing electrode layers.

### BACKGROUND OF THE INVENTION

1. Field of the Invention

The present invention relates to an electron emission device. In particular, the present invention relates to an electron emission device having driving electrodes for controlling the emission of electrons and a focusing electrode having a plurality of electrode layers for focusing the electrons, a display device including the same, and a method for manufacturing the same.

2. Description of Related Art

Electron emission devices may be generally classified into devices using hot cathodes as the electron emission source, and those using cold cathodes as the electron emission source. Types of cold cathode electron emission devices include, e.g., a field emitter array (FEA) type, a surface-conduction emission (SCE) type, a metal-insulator-metal (MIM) type, and a metal-insulator-semiconductor (MIS) type.

The FEA type electron emission device typically operates on the principle that, when a material having a low work function or a high aspect ratio is used as an electron emission source, electrons are easily emitted from the electron emission source when an electric field is applied thereto under a vacuum atmosphere. Examples of electron emission materials used for the electron emission source include, e.g., carbonaceous materials such as carbon nanotubes and graphite.

In a typical FEA type electron emission device, electron emission regions may be formed on a first substrate to act as electron emitters, along with cathode and gate electrodes that function as driving electrodes for controlling electron emission. Phosphor layers may be formed on a surface of a second substrate that faces the first substrate and may be coupled to an anode electrode for maintaining the phosphor layers at a suitably high potential (i.e., voltage). Furthermore, a focusing electrode may be formed on the electron emission regions and the driving electrodes to focus electrons emitted from the electron emission regions and inhibit the spreading of the electron beams.

In forming an electron emission device such as has been described, various techniques may be used to form the electron emission regions, e.g., direct growth, chemical vapor deposition, sputtering, screen printing, etc.

Among these techniques, screen printing may be particularly suitable for manufacturing a display device having a large area.

When the electron emission regions are formed using screen printing, a paste-phased mixture containing an electron emission material and a photosensitive material may be prepared and applied to structures formed on the first substrate. The applied mixture may be partially hardened, e.g., by selectively illuminating the mixture with ultraviolet rays, after which any non-hardened mixture may be removed through conventional developing processes.

It is desirable that the electron emission material not be left in regions other than the regions in which electron emission regions are formed. However, developing may leave electron emission material on structures such as the focusing electrode. This may give rise to undesirable properties in the resulting display device. For example, if electron emission material is left over on the focusing electrode, electrons may be emitted not only from the electron emission regions, but also from the electron emission material on the focusing electrode. This may occur, e.g., due to a voltage difference between the focusing electrode and the gate electrodes during the operation of the electron emission device. Consequently, unintended light emission of the phosphor layers may be induced, which may have deleterious effects on the quality of the display.

### SUMMARY OF THE INVENTION

The present invention is therefore directed to an electron emission device having driving electrodes for controlling the emission of electrons and a focusing electrode having a plurality of electrode layers for focusing the electrons, a display device including the same, and a method for manufacturing the same, which substantially overcome one or more of the problems due to the limitations and disadvantages of the related art.

It is therefore a feature of an embodiment of the present invention to provide an electron emission device having a focusing electrode including a plurality of focusing electrode layers.

It is therefore another feature of an embodiment of the present invention to provide a display device including the same.

It is therefore a further feature of an embodiment of the present invention to provide a method for manufacturing an electron emission device having a plurality of focusing electrode layers, wherein an electron emission region may be formed after the formation of a first focusing electrode layer.

At least one of the above and other features and advantages of the present invention may be realized by providing an electron emission device including an electron emission region, a focusing electrode formed on an insulating layer, and an opening passing through the focusing electrode and the insulating layer, the opening corresponding to the electron emission region, wherein the focusing electrode includes a plurality of focusing electrode layers.

The plurality of focusing electrode layers may include a first focusing electrode layer on the insulating layer and a second focusing electrode layer on the first focusing electrode layer, wherein the first focusing electrode layer is interposed between the second focusing electrode layer and the insulating layer. The first focusing electrode layer may be completely isolated from the opening and the second focusing electrode layer may have an area greater than an area of the first focusing electrode layer.

The opening may pass through the second focusing electrode layer, the first focusing electrode layer and the insulating layer, and the second focusing electrode layer may cover the first focusing electrode layer such that the first focusing electrode layer is not directly exposed to the opening. The electron emission device may also include an emissive material between at least two layers of the plurality of focusing electrode layers, wherein the electron emission region also includes the emissive material.

At least one of the above and other features and advantages of the present invention may also be realized by providing a display device including an electron emission section and a phosphor section, the electron emission section and the phosphor section disposed along opposite sides of a chamber, the electron emission section including an electron emission region and a focusing electrode arranged between the electron emission region and the phosphor section, wherein the focusing electrode may include first and second focusing electrode layers.

The display device may also include an opening in the focusing electrode, the opening corresponding to the electron emission region such that electrons emitted from the electron emission region pass through the opening to the phosphor section, wherein the first focusing electrode layer is not exposed to the opening.

At least one of the above and other features and advantages of the present invention may further be realized by providing a method for manufacturing an electron emission device, including forming an electron emission region on a substrate and forming a focusing electrode on an insulating layer on the substrate, the focusing electrode having a plurality of focusing electrode layers.

The method may include forming a first focusing electrode layer of the plurality of focusing electrode layers, forming an opening in the first focusing electrode layer and in the insulating layer, subsequent to forming the opening, providing an electron emission material on the substrate and directly on the first focusing electrode layer, and removing a portion of the electron emission material from the substrate to form the electron emission region. The method may also include, subsequent to the removing, forming a second focusing electrode layer on the first focusing electrode layer. The second focusing electrode layer may be formed to completely cover the first focusing electrode layer.

The method may also include removing a portion of the first focusing electrode layer from a periphery of the first focusing electrode layer around the opening before forming the second focusing electrode layer. Forming the second focusing electrode layer on the first focusing electrode layer may include forming the second focusing electrode layer in the periphery of the first focusing electrode layer around the opening. A trace of the electron emission material may remain on the first focusing electrode layer after the removing, and the second focusing electrode layer may cover the trace. The removing may include providing a light exposure mask having mask openings at a rear surface of the substrate and selectively passing ultraviolet rays through the mask openings.

The method may also include forming an opening in the insulating layer and in at least one focusing electrode layer, and, after forming the opening in the insulating layer and the at least one focusing electrode layer, removing a portion of the at least one focusing electrode layer around the opening to enlarge the opening in the at least one focusing electrode layer, such that a width of the opening in the at least one focusing electrode layer is larger than a width of the opening in the insulating layer. The method may also include forming a second focusing electrode layer on the first focusing electrode layer, wherein the second focusing electrode layer has an area larger than the first focusing electrode layer, such that the second focusing electrode layer entirely covers the first focusing electrode layer. The method may also include covering the electron emission regions with a protective film after forming the electron emission regions and after forming a first focusing electrode layer, and removing the protective film after forming a second focusing electrode layer.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates an exploded perspective view of an electron emission device according to an embodiment of the present invention;

FIG. 2 illustrates a sectional view of the electron emission device of FIG. 1;

FIG. 3 illustrates a partial enlarged view of the electron emission device of FIG. 2; and

FIGS. 4A to 4G illustrate schematic views of stages in a method for manufacturing an electron emission device according to the embodiment of the present invention.

### DETAILED DESCRIPTION OF THE INVENTION

Korean Patent Application No. 10-2005-0016843, filed on Feb. 28, 2005, in the Korean Intellectual Property Office, and entitled: “Electron Emission Device and Method for Manufacturing the Same,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. It will also be understood that when a layer is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present.

In an exemplary embodiment of the present invention, an electron emission device that has a focusing electrode including a plurality of layers, which may reduce or prevent the emission of electrons from the presence of electron emission material on the focusing electrode, thereby enhancing display characteristics.

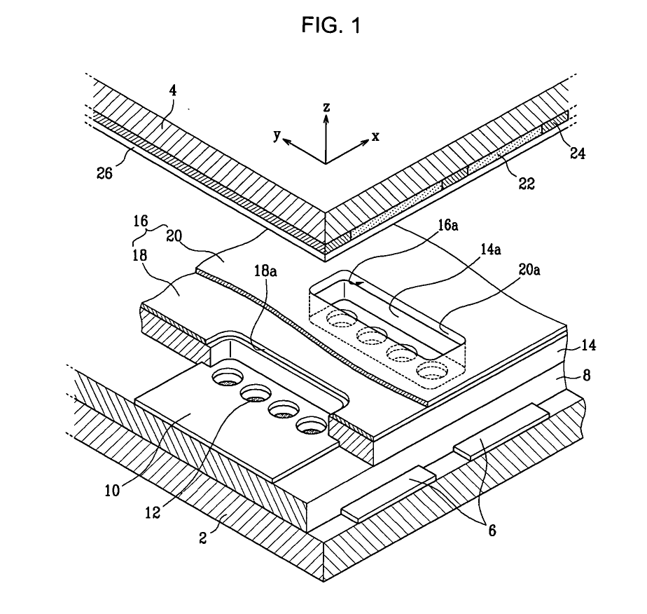

Referring to FIGS. 1, 2 and 3, an electron emission device according to the present invention may include a first substrate 2 and a second substrate 4, which may face each other and may be separated by a predetermined distance. An electron emission structure may be provided on the first substrate 2 and a light emission (or display) structure on the second substrate 4. The light emission structure may emit visible light in response to electrons from the electron emission structure. Thus, the light emission structure may produce a visible image or display.

Cathode electrodes 6 may be formed on the first substrate 2, e.g., in a striped pattern. A first insulating layer 8 may be formed on the entire surface of the first substrate 2 so as to cover the cathode electrodes 6. Gate electrodes 10 may be formed on the first insulating layer 8. Gate electrodes 10 may be arranged in a striped pattern and may be oriented perpendicular to the cathode electrodes 6.

The regions at which the cathode electrodes 6 and the gate electrodes 10 cross may be defined as pixel regions. One or more electron emission regions 12 may be formed on the cathode electrodes 6 at the pixel regions. The first insulating layer 8 and the gate electrodes 10 may have openings 8a and 10a formed respectively therein. These openings may correspond to the respective electron emission regions 12 to expose the electron emission regions 12 on the first substrate 2.

As illustrated, the electron emission regions 12 may have a circular aspect and may be linearly arranged along the length of the cathode electrodes 6 at the respective pixel regions. However, the shape, the number of regions 12 per pixel, the arrangement of the regions 12, etc., are not limited to the illustrated example, and may be altered in a variety of ways to suit the particular display.

The electron emission regions 12 may be formed using suitable materials that emit electrons under the application of an electric field, e.g., carbonaceous materials, nanometer-sized materials, etc. The electron emission regions 12 are preferably formed with carbon nanotube, graphite, graphite nanofiber, diamond, diamond-like carbon, C₆₀, silicon nanowire, or a combination thereof.

As illustrated, the gate electrodes 10 may be arranged over the cathode electrodes 6, with the first insulating layer 8 interposed between them. However, the present invention is not limited to this arrangement and other suitable arrangements may also be used, e.g., wherein the cathode electrodes 6 are over the gate electrodes 10. In the latter case, the electron emission region 12 may contact the one-sided surface of the cathode electrode 6.

A second insulating layer 14 and a focusing electrode 16 may be formed on the gate electrodes 10 and the first insulating layer 8. Openings 14a and 16a may also be formed in the second insulating layer 14 and the focusing electrode 16, respectively, exposing the electron emission regions 12 on the first substrate 2. A focusing electrode 16 may be formed on the entire surface of the first substrate 2, or may be patterned as a plurality of separate portions (not shown). The openings 14a and 16a may be provided at the respective pixel regions, one by one, to allow the focusing electrode 16 to collectively focus the electrons emitted at each pixel.

The focusing electrode 16 may include a multi-layered structure. For example, in an embodiment, the focusing electrode may include a double-layered structure, although the present invention is not limited to this embodiment. One layer of the multi-layered structure may be formed before the electron emission regions 12 are formed and another layer of the multi-layered structure may be formed after the electron emission regions are formed.

In an embodiment, the focusing electrode 16 may include a first focusing electrode layer 18 and a second focusing electrode layer 20. The first focusing electrode layer 18 may be formed before the formation of the electron emission regions 12, and the second focusing electrode layer 20 may be formed after the formation of the electron emission regions 12. Openings 20a in the second focusing electrode layer 20 are preferably established to have a width smaller than a width of openings 18a of the first focusing electrode layer 18. In other words, the first focusing electrode layer 18 may be formed under the second focusing electrode layer 20 and may be recessed beneath, and covered by, the second focusing electrode layer 20. Thus, the whole portion of the first focusing electrode layer 18, including the sidewall of the openings 18a thereof, is preferably not exposed to the second substrate 4. For clarity, the sidewall 18a, formed by the opening in the first focusing electrode layer 18, is illustrated in a cut-away in FIG. 1. However, as illustrated by feature 20a in FIG. 1, it is preferable that the sidewall 18a be enclosed by the second focusing electrode layer 20, such that only the sidewall 20a of the second focusing electrode layer 20 is exposed.

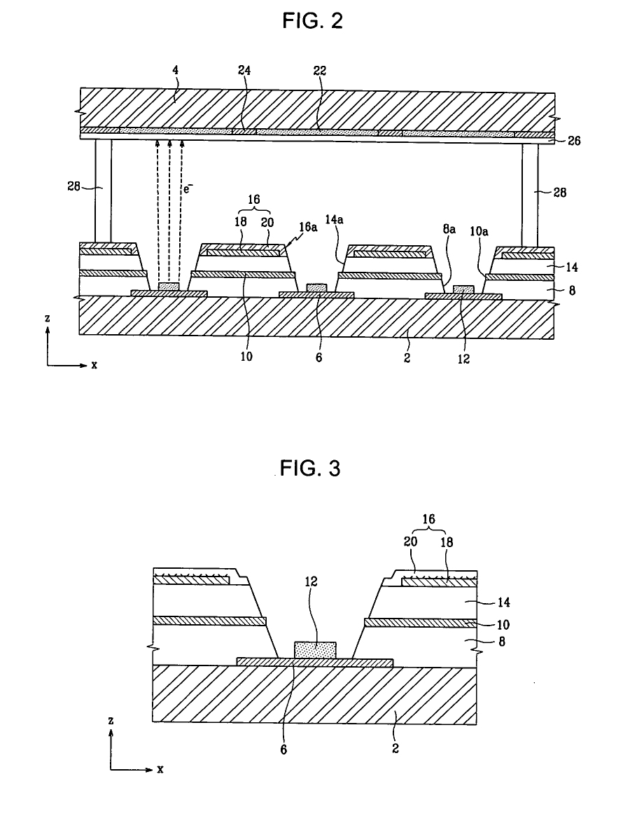

According to this embodiment of the present invention, even if electron emission material is deposited on the first focusing electrode layer 18, e.g., if traces of the electron emission material remain on the first focusing electrode layer 18 after the formation of the electron emission regions 12, the second focusing electrode layer may cover the electron emission material. Thus, any electron emission material on the first focusing electrode layer 18 may be isolated from the second substrate 4, and the emission of electrons from the electron emission material may be reduced or prevented. As an example, FIG. 3 illustrates a partial enlarged view of the electron emission device of FIG. 2, wherein remainders of electron emission material are illustrated on the first focusing electrode layer 18 and beneath the second focusing electrode layer 20.

A further advantage of the present invention derives from the increased thickness of the multi-layered focusing electrode. Thus, for example, where the focusing electrode 16 has a double-layered structure with a second focusing electrode layer 20 and a first focusing electrode layer 18, the whole thickness of the focusing electrode 16 is increased and the electron beam focusing efficiency may be enhanced, thereby improving display characteristics.

Other aspects of an exemplary device according to the present invention will now be described. Phosphor layers 22 and black layers 24 may be formed on a surface of the second substrate 4 facing the first substrate 2, and an anode electrode 26 may be formed on the phosphor layers 22 and the black layers 24, e.g., using a metallic material such as aluminum. The anode electrode 26 may receive a high voltage, required for accelerating the electrons, from outside the device, and may further reflect visible rays radiated from the phosphor layers 22 to the first substrate 2 back toward the second substrate 4, thereby improving display luminance.

The anode electrode 26 may also be formed with a transparent conductive material such as indium tin oxide (ITO). In this case, the anode electrode 26 may be arranged on a surface of the phosphor layers 22 and the black layers 24 facing the second substrate 4. The anode electrode 26 may be patterned with a plurality of separate portions.

Spacers 28 may be arranged between the first substrate 2 and the second substrate 4, which may then be sealed to each other at their peripheries using, e.g., a glass frit and a sealant. The inner space (or chamber) between the first and the second substrates 2 and 4 may be exhausted to a vacuum state, thereby forming a vacuum vessel. The spacers 28 may be located corresponding to non-light emitting regions corresponding to the black layers 24.

With the above-structured electron emission device, predetermined voltages may be applied to the cathode electrodes 6, the gate electrodes 10, the focusing electrodes 16 and the anode electrodes 26 to drive them. For instance, driving voltages with a voltage difference of several volts to several tens of volts may be applied to the cathode electrodes 6 and the gate electrodes 10, a minus (−) voltage of several volts to several tens of volts may be applied to the focusing electrodes 16 and a plus (+) voltage of several hundreds of volts to several thousands of volts may be applied to the anode electrodes 26.

Consequently, electric fields may be formed around the electron emission regions 12 at the pixels where the voltage difference between the cathode and the gate electrodes 6 and 10 exceeds the threshold value, and electrons may thus be emitted from the electron emission regions 12. The emitted electrons may be focused while passing the focusing electrodes 16, and are attracted by the high voltage applied to the anode electrodes 26, thereby colliding against the phosphor layers 22 to produce visible light.

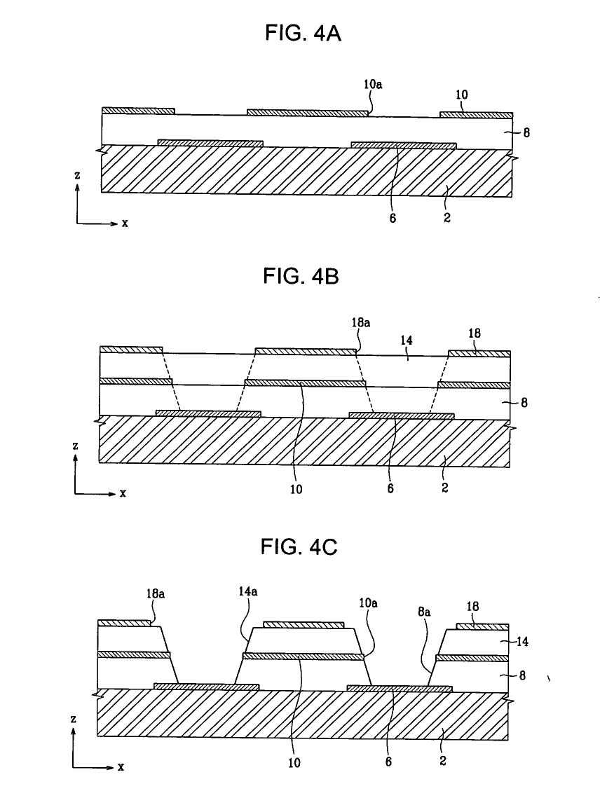

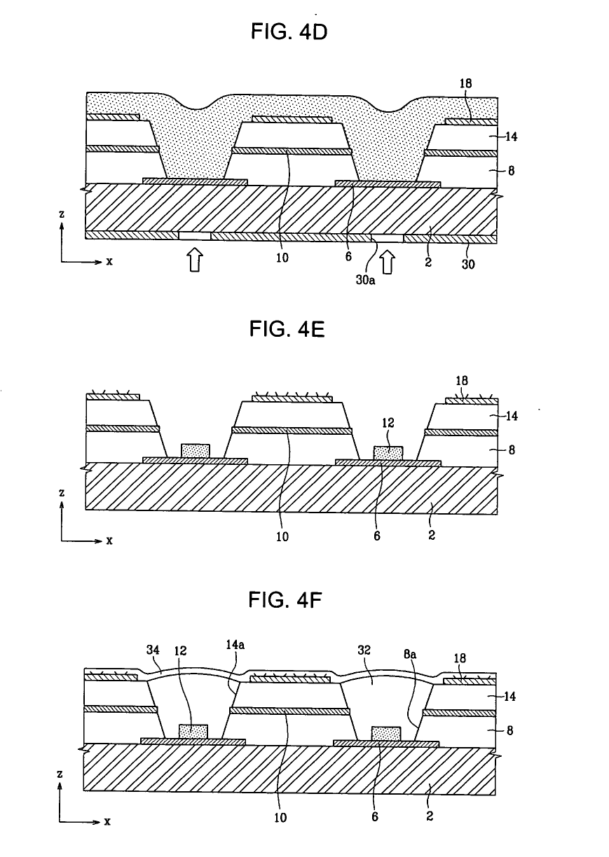

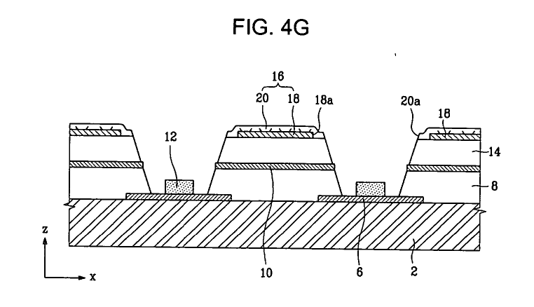

A method for manufacturing an electron emission device according to an embodiment of the present invention will be now explained with reference to FIGS. 4A to 4G. As illustrated in FIG. 4A, a conductive layer, e.g., a transparent conductive material such as ITO, may be coated onto a first substrate 2. The conductive layer may then be patterned, e.g., in a striped pattern, to form cathode electrodes 6. An insulating material may be coated onto the entire surface of the first substrate 2 to form a first insulating layer 8. A conductive layer may be coated onto the first insulating layer 8 and patterned, e.g., in a striped pattern perpendicular to the cathode electrodes 6, to form gate electrodes 10. One or more openings 10a may be formed in the gate electrodes 10 corresponding to pixel regions where the gate electrodes 10 cross the cathode electrodes 6.

As illustrated in FIG. 4B, an insulating material may be formed on the first insulating layer 8 and the gate electrodes 10 to form a second insulating layer 14. A conductive material may be coated onto the second insulating layer 14 to form a first focusing electrode layer 18. The first focusing electrode layer 18 may be patterned to form openings 18a therein, corresponding to the respective pixel regions where the cathode electrodes 6 and the gate electrodes 10 cross each other.

As illustrated in FIG. 4C, the first substrate 2 may be patterned, e.g., by dipping in an etching solution. Portions of the second insulating layer 14 exposed through the openings 18a of the first focusing electrode layer 18 may be removed to form openings 14a in the second insulating layer 14. Subsequently, portions of the first insulating layer 8 exposed through the openings 10a of the gate electrodes 10 may be removed, e.g., by etching, thereby forming openings 8a at the first insulating layer 8. As a result, the cathode electrodes 6 may be partially exposed through the openings.

Thereafter, portions of the first focusing electrode layer 18 around the openings 14a of the second insulating layer 14 may be removed, thereby forming openings 18a at the first focusing electrode layer 18, each with a width larger than the opening 14a of the second insulating layer 14. That is, portions of the first focusing electrode layer 18 may be removed from a periphery of the first focusing electrode layer 18 around the opening 18a, thereby enlarging the opening 18a. With this structure, when a second focusing electrode layer is formed on the first focusing electrode layer 18, the second focusing electrode layer 20 may be formed to have a larger area, i.e., a smaller opening, than the first focusing electrode layer 18. Thus, the second focusing electrode layer 20 can effectively cover the entire area of the first focusing electrode layer 18.

In detail, as illustrated in FIG. 4D, a paste-phased mixture may be prepared containing an electron emission material and a photosensitive material, and may be applied onto the structure of the first substrate 2.

Notably, the mixture may be applied directly on the first focusing electrode layer 18.

A light exposure mask 30 may be provided at the rear of the first substrate 2, and ultraviolet rays (indicated by the arrows) may be provided to illuminate the mixture on the cathode electrodes 6 from the rear of the first substrate 2, thereby hardening the mixture in a selective manner. The light exposure mask 30 may have mask openings 30a corresponding to the locations of the electron emission regions, and the ultraviolet rays may selectively pass through the mask openings 30a.

As illustrated in FIG. 4E, any non-hardened mixture may be removed, e.g., through developing. The remaining, hardened mixture may be dried and fired to thereby form electron emission regions 12. When the mixture is applied directly to the first focusing electrode layer 18, some electron emission material may remain on the first focusing electrode layer 18 after the non-hardened mixture is removed through developing.

As illustrated in FIG. 4F, protective films 32 may be formed in the openings 8a and 14a of the first and the second insulating layers 8 and 14, respectively, such that they fill the openings and cover the electron emission regions 12. A conductive film 34 may then be coated on the entire surface of the structure of the first substrate 2. As illustrated in FIG. 4G, the conductive film 34 may be patterned to form a second focusing electrode layer 20 with openings 20a, and the protective films 32 may be removed to again expose the electron emission regions 12.

Openings 20a may be formed in the second focusing electrode layer 20 such that they have a width smaller than the opening 18a of the first focusing electrode layer 18. That is, the second focusing electrode layer 20 may be formed to extend laterally beyond the periphery of the openings 18a and to extend down the sidewalls of the openings 18a. Thus, the second focusing electrode layer 20 preferably completely covers the first focusing electrode layer 18, including the sidewalls of the openings 18a. Accordingly, the area of the second focusing electrode layer 20 may be larger than that of the first focusing electrode layer 18.

A feature of this aspect of the present invention is that the second focusing electrode layer 20 covers any electron emission material left over on the first focusing electrode layer 18 after formation of the electron emission regions 12. Thus, the present invention may reduce or prevent the emission of electrons from the electron emission material during the operation of the electron emission device.

To complete the electron emission device, spacers may be fixed on the first substrate, and after the formation of phosphor layers, black layers and an anode electrode on the second substrate, the first and the second substrates may be sealed to each other at their peripheries using a glass frit.

The inner space (or chamber) between the first and the second substrates may then be exhausted.

As described above, with the electron emission device according to the present invention, even if electron emission material remains on the first focusing electrode layer 18 after the formation of the electron emission regions 12, the second focusing electrode layer 20 may serve to cover the electron emission material such that it is not exposed to the second substrate 4, which may reduce or prevent undesirable emission of electrons from the electron emission material. Accordingly, by implementing an electron emission device according to the present invention, screen color purity and color representation may be enhanced, thereby improving display characteristics.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An electron emission device, comprising:
an electron emission region;
a focusing electrode formed on an insulating layer; and
an opening passing through the focusing electrode and the insulating layer, the opening corresponding to the electron emission region,
wherein the focusing electrode includes a plurality of focusing electrode layers.

2. The electron emission device as claimed in claim 1, wherein the plurality of focusing electrode layers comprises:
a first focusing electrode layer on the insulating layer; and
a second focusing electrode layer on the first focusing electrode layer,
wherein the first focusing electrode layer is interposed between the second focusing electrode layer and the insulating layer.

3. The electron emission device as claimed in claim 2, wherein the first focusing electrode layer is completely isolated from the opening.

4. The electron emission device as claimed in claim 2, wherein the second focusing electrode layer has an area greater than an area of the first focusing electrode layer.

5. The electron emission device as claimed in claim 2, wherein the opening passes through the second focusing electrode layer, the first focusing electrode layer and the insulating layer, and wherein the second focusing electrode layer covers the first focusing electrode layer such that the first focusing electrode layer is not directly exposed to the opening.

6. The electron emission device as claimed in claim 1, further comprising:
an emissive material between at least two layers of the plurality of focusing electrode layers,
wherein the electron emission region also includes the emissive material.

7. A display device, comprising:
an electron emission section and a phosphor section, the electron emission section and the phosphor section disposed along opposite sides of a chamber, the electron emission section including:
an electron emission region; and
a focusing electrode arranged between the electron emission region and the phosphor section, wherein the focusing electrode includes first and second focusing electrode layers.

8. The display device as claimed in claim 7, further comprising:
an opening in the focusing electrode, the opening corresponding to the electron emission region such that electrons emitted from the electron emission region pass through the opening to the phosphor section,
wherein the first focusing electrode layer is not exposed to the opening.

9. A method for manufacturing an electron emission device, comprising:
forming an electron emission region on a substrate; and
forming a focusing electrode on an insulating layer on the substrate, the focusing electrode having a plurality of focusing electrode layers.

10. The method as claimed in claim 9, further comprising:
forming a first focusing electrode layer of the plurality of focusing electrode layers;
forming an opening in the first focusing electrode layer and in the insulating layer;
subsequent to forming the opening, providing an electron emission material on the substrate and directly on the first focusing electrode layer; and
removing a portion of the electron emission material from the substrate to form the electron emission region.

11. The method as claimed in claim 10, further comprising:
subsequent to the removing, forming a second focusing electrode layer on the first focusing electrode layer.

12. The method as claimed in claim 11, wherein the second focusing electrode layer is formed to completely cover the first focusing electrode layer.

13. The method as claimed in claim 11, further comprising removing a portion of the first focusing electrode layer from a periphery of the first focusing electrode layer around the opening before forming the second focusing electrode layer.

14. The method as claimed in claim 13, wherein forming the second focusing electrode layer on the first focusing electrode layer comprises forming the second focusing electrode layer in the periphery of the first focusing electrode layer around the opening.

15. The method as claimed in claim 11, wherein at least a trace of the electron emission material remains on the first focusing electrode layer after the removing, and wherein the second focusing electrode layer covers the trace.

16. The method as claimed in claim 10, wherein the removing includes providing a light exposure mask having mask openings at a rear surface of the substrate and selectively passing ultraviolet rays through the mask openings.

17. The method as claimed in claim 9, further comprising:
forming an opening in the insulating layer and in at least one focusing electrode layer; and
after forming the opening in the insulating layer and the at least one focusing electrode layer, removing a portion of the at least one focusing electrode layer around the opening to enlarge the opening in the at least one focusing electrode layer, such that a width of the opening in the at least one focusing electrode layer is larger than a width of the opening in the insulating layer.

18. The method as claimed in claim 17, further comprising forming a second focusing electrode layer on the first focusing electrode layer, wherein the second focusing electrode layer has an area larger than the first focusing electrode layer, such that the second focusing electrode layer entirely covers the first focusing electrode layer.

19. The method as claimed in claim 9, further comprising covering the electron emission regions with a protective film after forming the electron emission regions and after forming a first focusing electrode layer, and removing the protective film after forming a second focusing electrode layer.
